(19) United States
(12) Patent Application Publication
(10) Pub. No.: US 2023/0166212 A1
(43) Pub. Date: Jun. 1, 2023

(54) AUTOMATED CO2 CAPTURE PROCESS CONTROL SYSTEM WITH SOLVENT PROPERTY PREDICTION

(71) Applicant: University of Kentucky Research Foundation, Lexington, KY (US)

(72) Inventors: Bradley David Irvin, Lexington, KY (US); Kunlei Liu, Lexington, KY (US); Zhen Fan, Lexington, KY (US); Jonathan Pelgen, Lexington, KY (US)

(21) Appl. No.: 18/071,920

(22) Filed: Nov. 30, 2022

Related U.S. Application Data
(60) Provisional application No. 63/284,460, filed on Nov. 30, 2021.

(51) Int. Cl. B01D 53/14; B01D 53/30; B01D 53/18

(52) U.S. Cl. CPC B01D 53/1412; B01D 53/1475; B01D 53/30; B01D 53/18; B01D 53/1425; B01D 2257/504; B01D 2252/204

(57) ABSTRACT

A carbon dioxide capture process system includes an absorber vessel, a stripper, a first group of sensors and a second group[ of sensors. The first group of sensors is adapted for collecting real-time temperature, pH, density and viscosity data for a lean carbon capture solvent used for carbon capture from an acid gas adjacent the lean carbon capture solvent inlet. The second group of sensors is adapted for collecting real-time temperature, pH, density and viscosity data for a rich carbon capture solvent following carbon capture from the acid gas adjacent the rich carbon capture solvent inlet. A control system and related method are also described.

### RELATED APPLICATION

This application claims priority to U.S. Provisional Patent Application Ser. No. 63/284,460 filed on Nov. 30, 2021, hereby incorporated by reference in its entirety.

### TECHNICAL FIELD

This document generally relates to the capture of carbon dioxide (CO₂) and, more particularly, to an automated CO₂capture process control system and method with solvent property prediction.

### BACKGROUND

The cleanup of acid gasses, such as CO₂, from industrial processes is a long-practiced technology. This cleanup is done for technical, environmental, and/or regulatory reasons. As interest in removing acid gasses from industrial processes grow so does the need for larger, more efficient scrubbing plants. While several technologies exist for the removal of acid gasses, one of the most commonly employed methods is to use aqueous amines. In this process the basic amine solvent reacts with the acidic CO₂ to form carbamate or bicarbonate. The amount of CO₂ that is captured by the solvent ranges from 0 to some maximum loading measured in moles per kilogram of solvent (2.5 mol/kg for example). This measurement is known as carbon loading and its maximum is different depending on the solvent used.

While a process is in operation, its carbon loading is regularly required to determine needed changes in process parameters to minimize the energy consumption while the capture efficiency is maintained. However, it is difficult to measure the carbon loading on-line because of the frequent changes in solvent temperature, alkalinity and degradation of the solvent. The current solution to this problem requires the need of manually sampling and off-line analysis. This document relates to a new and greatly improved automated and fully on-line system and method for solvent quality prediction and CO₂ capture.

### SUMMARY

In accordance with the purposes and benefits described herein, a new and improved carbon dioxide capture process control system is provided. That control system comprises: (a) a first group of sensors adapted for collecting real-time temperature, pH, density and viscosity data for a lean carbon capture solvent used for the capture of an acid gas from a source fluid stream, (b) a second group of sensors adapted for collecting real-time temperature, pH, density and viscosity data for a rich carbon capture solvent following capture of the acid gas from the source fluid stream and (c) a controller adapted for (i) receiving the real-time temperature, pH, density and viscosity data for both the lean carbon capture solvent and the rich carbon capture solvent, (ii) determining carbon loading of the lean carbon capture solvent based upon the real-time temperature data and the real-time pH data for the lean carbon capture solvent and (iii) determining carbon loading of the rich carbon capture solvent based upon the real-time temperature data and the real-time pH data for the rich carbon capture solvent.

In at least one possible embodiment, the controller is further adapted for (a) determining alkalinity of the lean carbon capture solvent based upon the carbon loading, the real-time temperature and the real-time density of the lean carbon capture solvent and (b) determining alkalinity of the rich carbon capture solvent based upon the carbon loading, the real-time temperature and the real-time density of the rich carbon capture solvent.

In at least one possible embodiment, the controller is further adapted for (a) determining degradation of the lean carbon capture solvent based upon the carbon loading, the alkalinity and the real-time viscosity of the lean carbon capture solvent or (b) determining degradation of the rich carbon capture solvent based upon the carbon loading, the alkalinity and the real-time viscosity of the rich carbon capture solvent or (c) both.

The first group of sensors may include a first temperature sensor, a first pH sensor, a first density sensor and a first viscosity sensor. The second group of sensors includes a second temperature sensor, a second pH sensor, a second density sensor and a second viscosity sensor.

In one or more of the many possible embodiments of the carbon dioxide capture process control system, the control system further includes a third group of sensors adapted for sensing real-time physical parameters of the source fluid stream and a treated fluid stream (that is: the source fluid stream following CO₂ removal). That third group of sensors may include an inlet CO₂ concentration sensor, an outlet CO₂ concentration sensor and an inlet fluid stream flow-rate sensor.

In accordance with an additional aspect, a carbon dioxide capture process system is provided. That carbon dioxide capture process system comprises (a) an absorber vessel including a source fluid stream inlet, a lean carbon capture solvent inlet, a treated fluid stream outlet and a rich carbon capture solvent outlet and (b) a stripper including a rich carbon capture solvent inlet connected to the rich carbon capture solvent outlet, a lean carbon capture solvent outlet connected to the lean carbon capture solvent inlet and a captured carbon dioxide outlet. The carbon dioxide capture process system further comprises a first group of sensors adapted for collecting real-time temperature, pH, density and viscosity data for a lean carbon capture solvent, used for the capture of an acid gas from the source fluid stream, adjacent the lean carbon capture solvent inlet. Still further, the carbon dioxide capture process system further comprises a second group of sensors adapted for collecting real-time temperature, pH, density and viscosity data for a rich carbon capture solvent, following acid gas capture from the source fluid stream, adjacent the rich carbon capture solvent inlet. In addition, the carbon dioxide capture process system further comprises a controller adapted for (a) receiving the real-time temperature, pH, density and viscosity data for both the lean carbon capture solvent and the rich carbon capture solvent, (b) determining carbon loading of the lean carbon capture solvent based upon the real-time temperature data and the real-time pH data for the lean carbon capture solvent and (c) determining carbon loading of the rich carbon capture solvent based upon the real-time temperature data and the real-time pH data for the rich carbon capture solvent.

In one or more of the many possible embodiments, the controller is further adapted for (a) determining alkalinity of the lean carbon capture solvent based upon the carbon loading, the real-time temperature and the real-time density of the lean carbon capture solvent and (b) determining alkalinity of the rich carbon capture solvent based upon the carbon loading, the real-time temperature and the real-time density of the rich carbon capture solvent.

In one or more of the many possible embodiments, the controller is further adapted for (a) determining degradation of the lean carbon capture solvent based upon the carbon loading, the alkalinity and the real-time viscosity of the lean carbon capture solvent or (b) determining degradation of the rich carbon capture solvent based upon the carbon loading, the alkalinity and the real-time viscosity of the rich carbon capture solvent or (c) both.

The first group of sensors may include a first temperature sensor, a first pH sensor, a first density sensor and a first viscosity sensor. The second group of sensors may include a second temperature sensor, a second pH sensor, a second density sensor and a second viscosity sensor.

In one or more of the many possible embodiments, the carbon dioxide capture process system may further include at least one or more additional sensors adapted for collecting real-time data related to:

(a) CO₂ concentration of the source fluid stream upstream from the source fluid stream inlet;

(b) source fluid stream flow rate through the source fluid stream inlet;

(c) CO₂ concentration of the treated fluid stream downstream of the treated fluid stream outlet;

(d) flow rate of captured carbon dioxide downstream from the captured carbon dioxide outlet;

(e) flow rate of carbon capture solvent through the absorber vessel and the stripper;

(f) surface tension of the carbon capture solvent at various locations in the carbon dioxide capture system;

(g) liquid-to-gas ratio in the absorber vessel; and

(h) cooling water temperature at various locations in the carbon dioxide capture system.

At least one possible embodiment of the carbon dioxide capture process system, includes a source of carbon capture solvent and a pump and valve system for delivering fresh carbon capture solvent from the carbon capture solvent source to the absorber vessel wherein the controller controls operation of the pump and valve system to (a) make-up the carbon capture solvent at a rate necessary to maintain a desireable carbon capture solvent quality and (b) periodically replace the carbon capture solvent circulating between the absorber vessel and the stripper.

At least one possible embodiment of the carbon dioxide capture process system, includes a carbon capture solvent reboiler in communication with the stripper wherein the controller controls operation of the reboiler to maintain a desired operating temperature and a desired operating pressure within the stripper.

In accordance with yet another aspect, a method of controlling carbon capture in a carbon capture system is provided. That method comprises the steps of: (a) collecting real-time temperature, pH, density and viscosity data for a lean carbon capture solvent used for the capture of an acid gas from a source fluid stream, (b) collecting real-time temperature, pH, density and viscosity data for a rich carbon capture solvent following the capture of the acid gas from the source fluid stream, (c) receiving, by a controller, the real-time temperature, pH, density and viscosity data for both the lean carbon capture solvent and the rich carbon capture solvent, (d) determining, by the controller, carbon loading of the lean carbon capture solvent based upon the real-time temperature data and the real-time pH data for the lean carbon capture solvent, and (e) determining, by the controller, carbon loading of the rich carbon capture solvent based upon the real-time temperature data and the real-time pH data for the rich carbon capture solvent.

In one or more of the many possible embodiments of the method, the method also includes the steps of: (a) determining, by the controller, alkalinity of the lean carbon capture solvent based upon the carbon loading, the real-time temperature and the real-time density of the lean carbon capture solvent and (b) determining, by the controller, alkalinity of the rich carbon capture solvent based upon the carbon loading, the real-time temperature and the real-time density of the rich carbon capture solvent.

In one or more of the many possible embodiments of the method, the method also includes the steps of: (a) determining, by the controller, degradation of the lean carbon capture solvent based upon the carbon loading, the alkalinity and the real-time viscosity of the lean carbon capture solvent or (b) determining, by the controller, degradation of the rich carbon capture solvent based upon the carbon loading, the alkalinity and the real-time viscosity of the rich carbon capture solvent or (c) both.

In one or more of the many possible embodiments of the method, the method also includes the step of: locating a first group of sensors adapted for the collecting of the real-time temperature, pH, density and viscosity data for the lean carbon capture solvent upstream from a lean carbon capture solvent inlet in an absorber vessel of a carbon dioxide capture process system. In one or more of the many possible embodiments of the method, the method also includes the step of: locating a second group of sensors adapted for the collecting of the real-time temperature, pH, density and viscosity data for the rich carbon capture solvent upstream from a rich carbon capture solvent inlet in a stripper of a carbon dioxide capture process system.

In the following description, there are shown and described several embodiments of the carbon dioxide capture process system, the control system for the carbon dioxide capture process system and the related method for controlling carbon capture in an carbon capture system. As it should be realized, the systems and method are capable of other, different embodiments and their several details are capable of modification in various, obvious aspects all without departing from the systems and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification illustrate several aspects of the (a) carbon dioxide capture process system, (b) the control system for the carbon dioxide capture process system and (c) the related method for controlling carbon capture in an carbon capture system and together with the description serve to explain certain principles thereof.

FIG. 1A is a schematic illustration of the carbon dioxide capture process system.

FIG. 1B is a schematic illustration of the control system for the carbon dioxide capture process system that is illustrated in FIG. 1.

FIG. 2A is a graphic illustration of the correlation between temperature, pH and carbon loading. The equation, A+xB+yC+Dx²+Eyx+Fy²+Gx³+Hx²y+Lxy²+Jy³ . . . , that governs this correlation is the model which is used to predict the carbon loading of inline process solvent.

FIG. 2B is a graphic illustration that shows that a neural network version of the carbon loading model produces a similar result with an R²=0.9989.

FIG. 3 is a graphic illustration that shows the probability of agreeance between the Lab measured carbon-to-nitrogen ratio (C/N) and the model predicted C/N method that falls on a standard distribution with a standard deviation of 7.27%. The error in the laboratory measurements for C/N were 3.18%, 1 stdev and 3.21%, 1 stdev for the model estimates.

FIG. 4 is a graphic illustration that shows the relationship between the alkalinity of MEA to density, C/N, and temperature.

FIG. 5A is a graphic illustration that shows that at static conditions an increase in viscosity due to degradation lowers capture rate.

FIG. 5B is a graphic illustration that shows the correlation between total degradation and viscosity and alkalinity.

FIG. 6 is a flow chart showing how solvent properties can be estimated using inline sensors to feed laboratory derived models.

FIG. 7A is a graphic illustration that shows the correlation between Temperature, pH, and C/N as pH decreases and temperature increases C/N increases.

FIG. 7B is a graphic illustration that shows the effects of amine concentration (monoethanolamine) on pH as a function of temperature at different C/N.

FIG. 7C is a graphic illustration that shows the correlation between density, C/N, and amine concentration.

FIG. 8A is a graphic illustration that shows that the model predictions for alkalinity and C/N agree with the measured values over a 22 day period at stable conditions.

FIG. 8B is a graphic illustration that shows that he model predictions for alkalinity and C/N throughout a single day of operation reflect the changes in the process through start up, steady state, and shut down.

FIG. 9 is an integrated control schematic that shows how solvent property estimations along with sensor inputs and performance targets can be used as inputs to automatically control the operational parameters of a CO₂ capture process with the optional use of a neural network.

### DETAILED DESCRIPTION

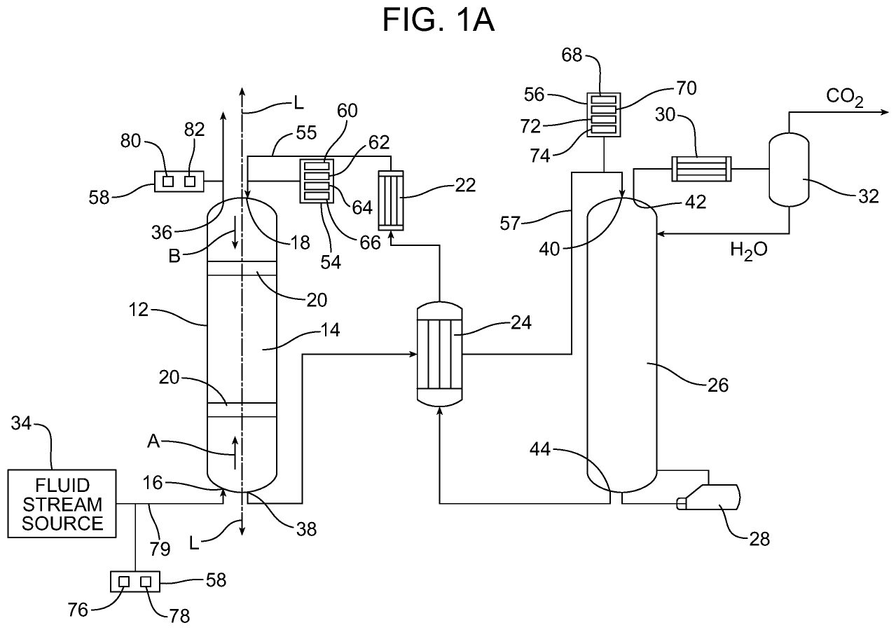

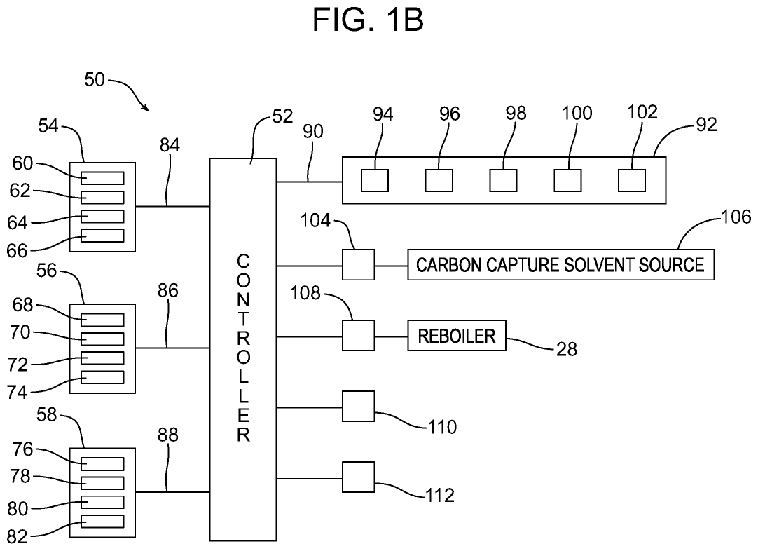

Reference is now made to FIG. 1A which schematically illustrates a carbon dioxide capture process system 10 of the type utilized to remove and capture an acid gas, carbon dioxide, from a source fluid stream. As illustrated, the carbon dioxide capture process system 10 includes an absorber vessel 12, having an internal chamber 14. The absorber vessel 12 may be in the form of an absorber tower that has a longitudinal axis L oriented in a vertical direction. The absorber vessel 12 includes a source fluid stream inlet 16 adjacent the lowermost end and a lean carbon capture solvent inlet 18 adjacent the uppermost end. The two inlets 16, 18 are opposed so as to establish a counterflow within the chamber 14.

At least one packing element 20 may be held in the chamber 14. As depicted in FIG. 1A, two packing elements 20 are illustrated but more could be provided. The packing elements 20 are fixed within the chamber 14 of the absorber vessel 12 and extend across the longitudinal axis L.

The carbon dioxide capture process system 10 also includes a cooler 22, a heat exchanger 24, a stripper 26, a reboiler 28, a condenser 30 and a gas-liquid separator 32.

A fluid stream source 34 generates a source fluid stream, in the form of a gas, that is delivered to the absorber vessel 12 through the source fluid stream inlet 16. That source fluid stream flows upward in the direction of action arrow A through the chamber 14 of the absorber vessel 12. Simultaneously, a CO₂ lean aqueous scrubbing solution or lean carbon capture solvent is delivered to the absorber vessel 12 through the lean carbon capture solvent inlet 18. The lean carbon capture solvent flows downward in the direction of action arrow B through the chamber 14 of the absorber vessel 12.

The lean carbon capture solvent is adapted to remove an acid gas, in this case carbon dioxide, from the source fluid stream. Toward this end, the lean carbon capture solvent may include an aqueous amine such as, for example, monoethanolamine (MEA), hexanediamine (HAD), N,N-Bis(2-hydroxyethyl)methyl-amine (MDEA), piperazine (PZ), 2-amino-2-methyl propanol (AMP) or combinations thereof. As is known in the art, the lean carbon capture solvent in addition to water, may also include other appropriate additives including, for example, corrosions inhibitors, solvent oxidation inhibitors and foaming inhibitors.

Following reaction, the treated fluid stream, the source fluid stream minus carbon dioxide, is exhausted from the top of the absorber vessel 12 at the treated fluid stream outlet 36. The now CO₂-rich carbon capture solvent is discharged at the rich carbon capture solvent outlet 38 from the bottom of the absorber vessel 12 and routed to the heat exchanger 24 before being routed to the rich carbon capture solvent inlet 40 at the top of the stripper 26. The carbon capture solvent at the bottom of the stripper 26 is circulated through the reboiler 28 where it is heated and then returned to the stripper. The rich carbon capture solvent entering the top of the stripper 26 is heated in the stripper, causing the release of the CO₂ and the regeneration of the lean carbon capture solvent.

The released CO₂ and some water vapor is exhausted from the captured carbon dioxide outlet 42 at the top of the stripper 26 and delivered through the condenser 30 to the gas-liquid separator 32. The separated CO₂ is collected for further processing or long term storage while the separated water is returned to the stripper 26. The lean carbon capture solvent, regenerated in the scrubber 26, is then returned from the stripper 26 through the lean carbon capture solvent outlet 44, the heat exchanger 24 and then the cooler 22 to the absorber vessel 12 through the lean carbon capture solvent inlet 18 in order to restart the process cycle.

The carbon dioxide capture process system 10 further includes a control system 50 (see also FIG. 1B) which takes sensory inputs (e.g. density, pH, viscosity and the local temperature for those measurements), determines carbon loading, alkalinity, and degradation concentration then outputs changes to the process parameters usually with the goal of achieving minimum energy consumption while providing rapid response to external loading changes and the maintaining of a desired process efficiency. Carbon loading is used to calculate cyclic capacity and is one of the primary measurements for determining process efficiency, solvent alkalinity is used to control the chemical make-up rate for maintaining a desirable solvent quality while the degradation concentration is used to adjust the solvent reclaiming frequency and duration.

As illustrated in FIGS. 1A and 1B, the control system 50 of the illustrated embodiment includes a controller 52, a first group of sensors 54, a second group of sensors 56 and a third group of sensors 58. The controller 52 may comprise a computing device, such as (a) an electronic control unit (ECU), operating in accordance with instructions from appropriate control software, or (b) a dedicated microprocessor with appropriate hardware control.

The first group of sensors 54 is adapted for collecting real-time temperature, pH, density and viscosity data for the lean carbon capture solvent being delivered from the stripper 26 to the absorber vessel 12 through the lean carbon capture solvent inlet 18. Toward this end, the first group of sensors 54 may be located adjacent the lean carbon capture solvent inlet 18. In the illustrated embodiment, the first group of sensors 54 is located in the lean carbon capture solvent line 55 just upstream from the lean carbon capture solvent inlet 18 and downstream from the lean carbon capture solvent outlet 44 and the heat exchanger 24. In other embodiments, the first group of sensors 54 could be located at other positions in the lean carbon capture solvent line or just inside the absorber vessel 12 near the inlet 18. The first group of sensors 54 may include a first temperature sensor 60, a first pH sensor 62, a first density sensor 64 and a first viscosity sensor 66.

The second group of sensors 56 is adapted for collecting real-time temperature, pH, density and viscosity data for the rich carbon capture solvent being delivered from the absorber vessel 12 to the stripper 26 through the rich carbon capture solvent inlet 40. Toward this end, the second group of sensors 56 may be located adjacent the rich carbon capture solvent inlet 40. In the illustrated embodiment, the second group of sensors 56 is located in the rich carbon capture solvent line 57 just upstream from the rich carbon capture solvent inlet 40 and downstream from the rich carbon capture solvent outlet 38 and the heat exchanger 24. In other embodiments, the second group of sensors 56 could be located at other positions in the rich carbon capture solvent line 57 or just inside the stripper 26 near the inlet 40. The second group of sensors 54 may include a second temperature sensor 68, a second pH sensor 70, a second density sensor 72 and a second viscosity sensor 74.

The third group of sensors 58 is adapted for sensing real-time physical parameters of the source fluid stream and the treated fluid stream. Toward this end, the third group of sensors 58 includes (a) an inlet CO₂ concentration sensor 76 and an inlet source fluid stream flow rate sensor 78 in the line 79 between the fluid stream source 34 and the source fluid stream inlet 16 as well as (b) an outlet CO₂ concentration sensor 80 and an outlet treated gas flow rate sensor 82 in the line 81 downstream from the treated fluid stream outlet 36.

As illustrated in FIG. 1B, the controller 52 is connected by data line 84 to the first group of sensors 54. In this way, the controller 52 is adapted to receive the real-time temperature, pH, density and viscosity data collected by the sensors 60, 62, 64 and 66 for the lean carbon capture solvent. The controller 52 is also connected by the data line 86 to the second group of sensors 56. In this way, the controller 52 is adapted to receive the real-time temperature, pH, density and viscosity data collected by the sensors 68, 70, 72 and 74 for the rich carbon capture solvent. The controller 52 is also connected by the data line 88 to the third group of sensors 58. In this way, the controller is adapted to receive the inlet CO₂ concentration, outlet CO₂ concentration, inlet fluid stream flow-rate and outlet treated fluid stream flow rate data collected by the sensors 76, 78, 80 and 82.

As will be discussed in greater detail below, the controller 52 is also adapted to determine (a) the carbon loading of the lean carbon capture solvent based upon the real-time temperature data and the real-time pH data for the lean carbon capture solvent and (b) the carbon loading of the rich carbon capture solvent based upon the real-time temperature data and the real-time pH data for the rich carbon capture solvent. Still further, the controller 52 is adapted to determine (a) the alkalinity of the lean carbon capture solvent based upon the carbon loading, the real-time temperature and the real-time density of the lean carbon capture solvent and (b) the alkalinity of the rich carbon capture solvent based upon the carbon loading, the real-time temperature and the real-time density of the rich carbon capture solvent.

Still further, the controller 52 may also be adapted to (a) determine the degradation of the lean carbon capture solvent based upon the carbon loading, the alkalinity and the real-time viscosity of the lean carbon capture solvent or (b) determine the degradation of the rich carbon capture solvent based upon the carbon loading, the alkalinity and the real-time viscosity of the rich carbon capture solvent or (c) both.

In addition, the controller 52 may be adapted to control the entire carbon capture process in order to optimize the performance of the carbon dioxide capture process system 10. Toward this end, the controller may be connected by data line 90 to an additional group of sensors 92, including at least one of: (a) CO₂ concentration of the source fluid stream upstream from the source fluid stream inlet, (b) source fluid stream flow rate through the source fluid stream inlet,

(c) CO₂ concentration of the treated fluid stream downstream of the treated fluid stream outlet,

(d) a sensor or an array of sensors 94 for collecting real-time data relating to the flow rate of captured carbon dioxide downstream from the captured carbon dioxide outlet 42, (e) a sensor or an array of sensors 96 for collecting real-time data relating to flow rate of carbon capture solvent through the absorber vessel 12 and the stripper 26, (f) a sensor or an array of sensors 98 for collecting real-time data relating to surface tension of the carbon capture solvent at various locations in the carbon dioxide capture system, (g) a sensor or an array of sensors 100 for collecting real-time data relating to liquid to gas ratio in the absorber, and (h) a sensor or an array of sensors 102 for collecting real-time data relating to cooling water temperature at various locations in the carbon dioxide capture system 10.

As further examples, the controller 52 may be connected to a pump and valve system 104, adapted for delivering fresh carbon capture solvent from a carbon capture solvent source 106 to the absorber vessel 12. In this way, the controller 52 controls operation of the pump and valve system 104 to (a) make-up the carbon capture solvent at a rate necessary to maintain a desireable carbon capture solvent quality and (b) periodically replace the carbon capture solvent circulating between the absorber and the stripper. In addition, the controller 52 may be connected to the heating element and pump 108 of the reboiler 28 so as to allow the controller to control operation of the reboiler to maintain a desired operating temperature and a desired operating pressure within the stripper 26. Still further, the controller 52 may be connected (a) to one or more cooling water pumps 110 to control cooling of the carbon dioxide capture process system 10 at one or more locations and (b) to a pump 112 to control the fluid stream gas flow rate from the source 34.

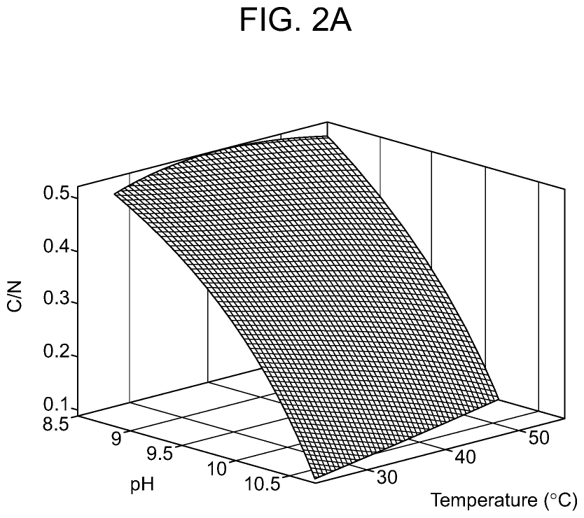

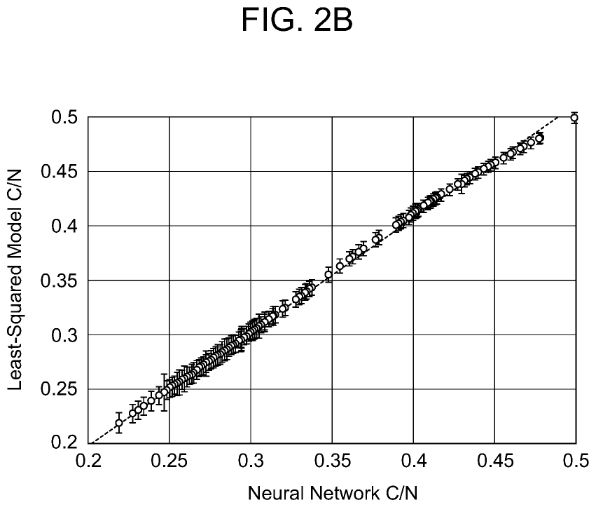

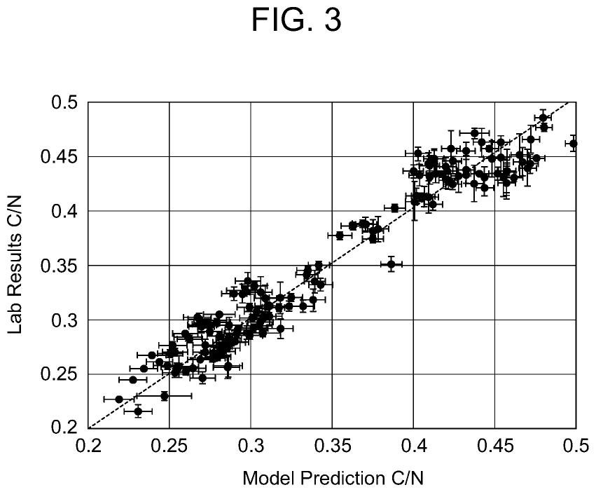

For any aqueous solvent, the density will be dominated by alkalinity, pH is determined by carbon loading for a given alkalinity, and viscosity are predominated by carbon loading and the content of solvent degradation product. For instance, as the carbon loading of solvent increases the pH of the solvent becomes more acidic, a measure of this pH and temperature can be used as inputs to a heuristic model and carbon loading can be obtained. The heuristic model is developed from solvent chemistry verified with a known set of loading, pH, and temperature correlation and its dependent on the type of solvent used. This model, as shown in FIG. 2, can be as simple as an equation or it can even be as complicated as a neural network or other type of artificial intelligence. FIG. 3 illustrated how the lab measured and model predicted C/N tend to agree.

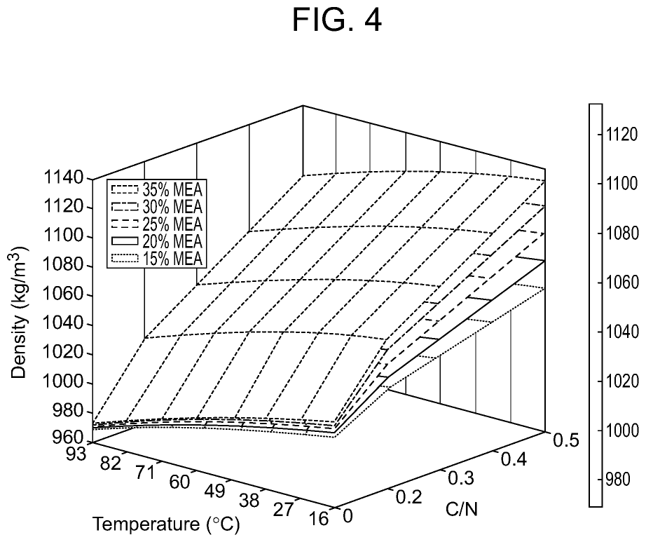

Similar methods can be used to determine alkalinity with the use of density, temperature, and carbon loading as input and an example created using Aspen Plus Dynamics® simulation of MEA is shown in FIG. 4. As a process continues to operate over a length of time the alkalinity of the solvent changes due to losses from exhaust vapor or entrainment originating in the absorber/stripper. Conversely, water can enter the system through saturated inlet gas, and process equipment. Alkalinity is an important process parameter which needs to be monitored.

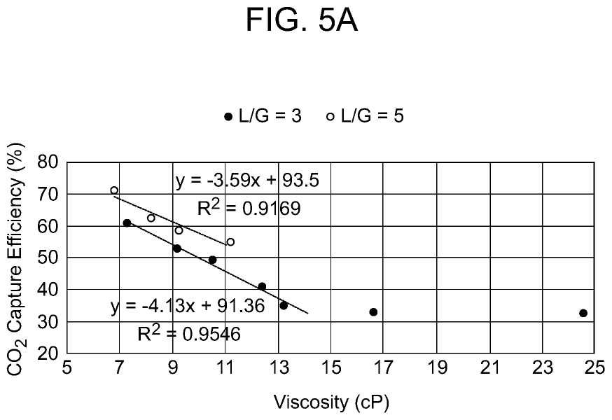

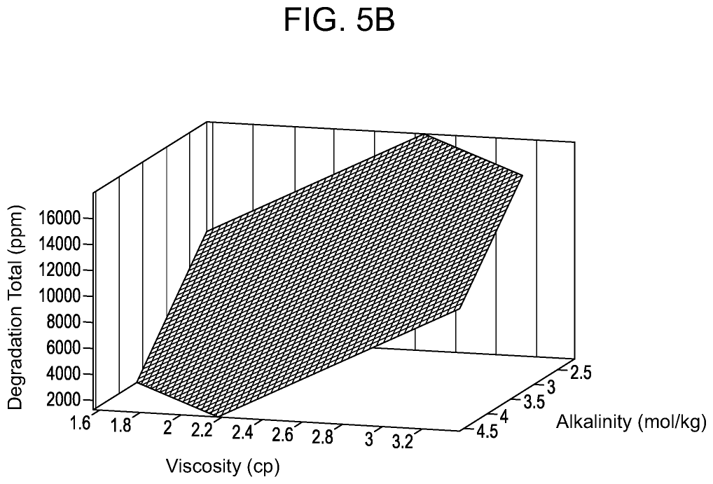

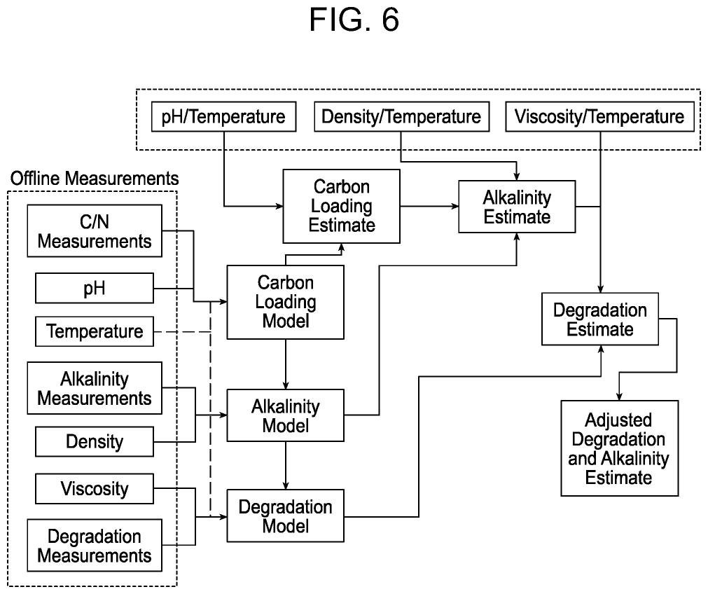

Degradation including thermal stable salts can be derived from the carbon loading and alkalinity estimations with on-line measured viscosity and its local temperature shown in FIGS. 5A and 5B. Additionally, shown is the effect of an increasing viscosity on process performance caused by a buildup of degradation products in the solvent. This highlights the need for monitoring and removing degradation products. A degradation model can also be verified with off-line physical property measurements and concentration measurements of individual degradation products. Degradation of the solvent occurs as it is exposed to the high temperatures in the stripper and flue gas impurities forming heat stable salts. Additionally, the exposure of the solvent to oxygen can also cause oxidative degradation. How the carbon loading, alkalinity, and degradation estimation models work together can be visualized in FIG. 6.

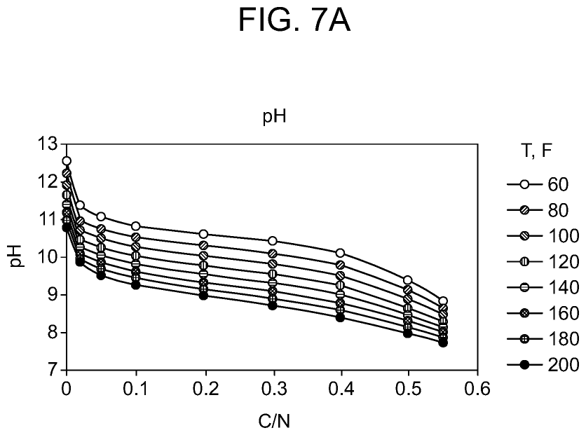

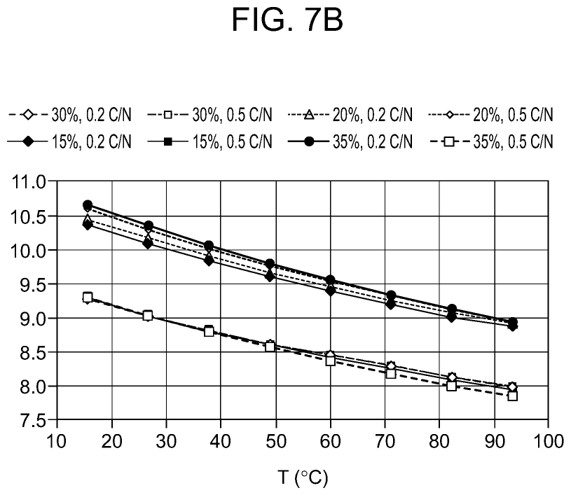

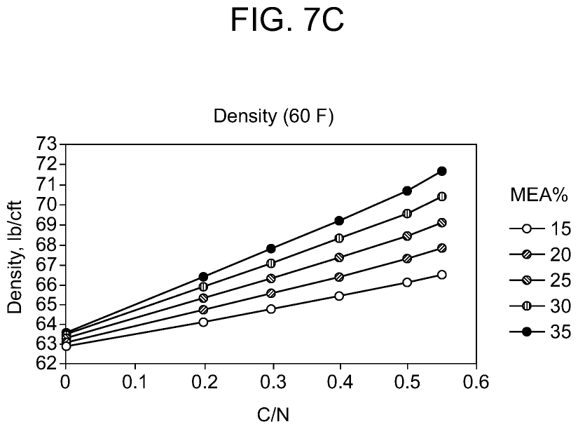

These heuristic models are derived from the individual physical properties and their relationship to carbon loading and alkalinity. This relationship is a fundamental aspect of the solvent chemistry and has been modeled using Aspen Plus Dynamics® modeling software, as shown in FIGS. 7A-7C. These models served as the basis for creating the heuristic models. The functionality of these models hinges on the strong negative correlation of carbon loading to pH and pH to temperature. However, the correlation of amine concentration to pH is weakly positive at low carbon loading and shrinks as temperature increases. At high loadings, this correlation is weakly negative and shrinks as temperature decreases. Density is positively correlated to both C/N and amine concentration (alkalinity).

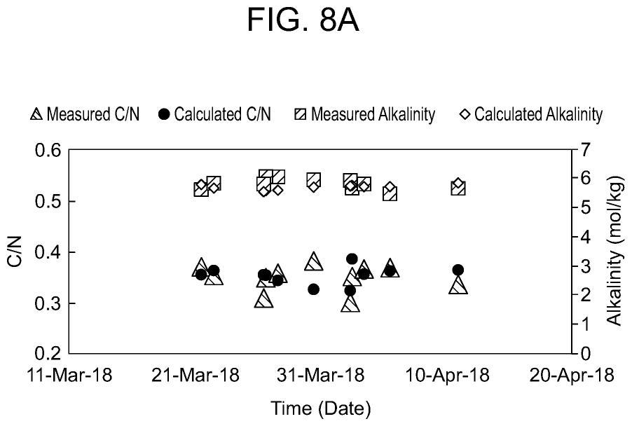

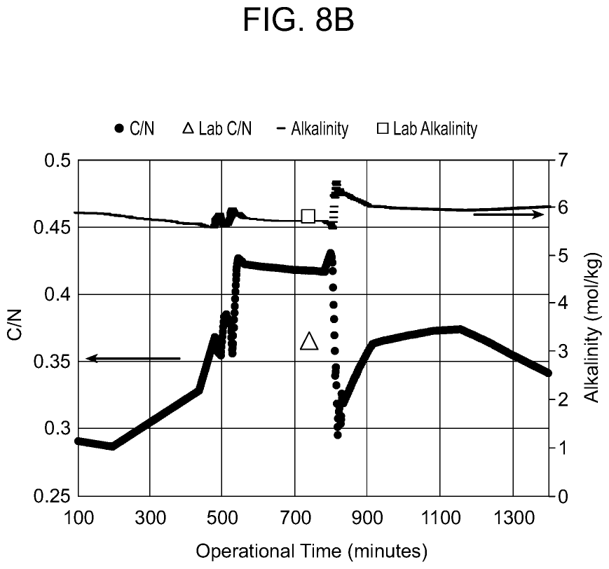

On-line measurements of the carbon loading and alkalinity were conducted at UK-CAER 0.7 MWe CO₂ capture small pilot plant located at Brown Station power plant in Harrodsburg Ky. Alkalinity and C/N predictive accuracy, over a long period of steady state time, shown in FIG. 8A, is stable. The model predictions for alkalinity are within a standard deviation of 0.252 mol/kg, which is greater than the 0.055 mol/kg standard deviation in repeated measurements. C/N model predictions are accurate within a standard deviation of 0.028 mol/kg of the measured value while the error in repeated measurements is 0.017 mol/kg.

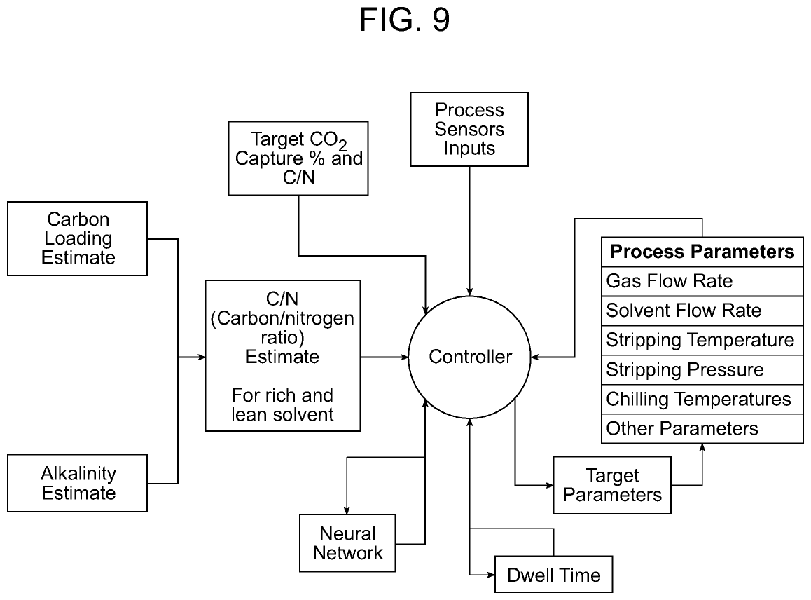

When operating an acid gas cleanup process, it is desirable to maintain a target capture percentage with fast response energy consumption. If the physical characteristics of the inlet acid gas and ambient conditions changes then the process parameters need to change rapidly in order to maintain the targeted performance while minimizing energy expenditures. For situations like this adjusting the liquid to gas (L/G) ratio and reboiler (stripper) temperature/pressure and other process parameters may be required. An advanced control algorithm, as shown in FIG. 9, can read sensory inputs and output the necessary process parameter changes to maintain a targeted performance in the forward-feed control. However, due to large inventory in the capture system, once adjustments are made to the process parameters it can take up to half hour or more for those to changes to be reflected in the C/N of the solvent. For this, dwell time is needed before large changes to the operating parameters should be made. Preloaded predictive models, such as a neural network, can be used to minimize the numbers of changes needed and reduce the time required to reach the targeted process performance. The predicted C/N and alkalinity are a crucial algorithmic inputs for achieving this capability.

Sensory inputs to the control scheme include, but are not limited to, CO₂ concentration (inlet and outlet), CO₂ product flowrate, source fluid stream flow rate, solvent flow rate throughout the process, liquid to gas ratio in the absorber, solvent inventory, solvent alkalinity, solvent pH coupled with temperature at various location, temperature of the solvent and gas throughout the process, pressure of solvent and gas throughout the process, solvent density and coupled temperature, solvent viscosity and surface tension with coupled temperature throughout the process, and cooling water temperature throughout the process.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a sensor”, as used herein, may also refer to, and encompass, a plurality of sensors.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the control system, carbon dioxide capture process system, and related method of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A carbon dioxide capture process control system, comprising:
a first group of sensors adapted for collecting real-time temperature, pH, density and viscosity data for a lean carbon capture solvent used for capture of an acid gas from a source fluid stream;
a second group of sensors adapted for collecting real-time temperature, pH, density and viscosity data for a rich carbon capture solvent following capture of the acid gas from the source fluid stream; and
a controller adapted for (a) receiving the real-time temperature, pH, density and viscosity data for both the lean carbon capture solvent and the rich carbon capture solvent, (b) determining carbon loading of the lean carbon capture solvent based upon the real-time temperature data and the real-time pH data for the lean carbon capture solvent and (c) determining carbon loading of the rich carbon capture solvent based upon the real-time temperature data and the real-time pH data for the rich carbon capture solvent.

2. The carbon dioxide capture process control system of claim 1, wherein the controller is further adapted for (a) determining alkalinity of the lean carbon capture solvent based upon the carbon loading, the real-time temperature and the real-time density of the lean carbon capture solvent and (b) determining alkalinity of the rich carbon capture solvent based upon the carbon loading, the real-time temperature and the real-time density of the rich carbon capture solvent.

3. The carbon dioxide capture process control system of claim 2, wherein the controller is further adapted for (a) determining degradation of the lean carbon capture solvent based upon the carbon loading, the alkalinity and the real-time viscosity of the lean carbon capture solvent or (b) determining degradation of the rich carbon capture solvent based upon the carbon loading, the alkalinity and the real-time viscosity of the rich carbon capture solvent or (c) both.

4. The carbon dioxide capture process control system of claim 3, wherein the first group of sensors includes a first temperature sensor, a first pH sensor, a first density sensor and a first viscosity sensor.

5. The carbon dioxide capture process control system of claim 4, wherein the second group of sensors includes a second temperature sensor, a second pH sensor, a second density sensor and a second viscosity sensor.

6. The carbon dioxide capture process control system of claim 5, further including a third group of sensors adapted for sensing real-time physical parameters of the source fluid stream and a treated fluid stream.

7. The carbon dioxide capture process control system of claim 4, wherein (a) the third group of sensors includes an inlet CO₂ concentration sensor, an outlet CO₂ concentration sensor and an inlet source fluid stream flow-rate sensor.

8. A carbon dioxide capture process system, comprising:
an absorber vessel including a source fluid stream inlet, a lean carbon capture solvent inlet, a treated fluid stream outlet and a rich carbon capture solvent outlet;
a stripper including a rich carbon capture solvent inlet connected to the rich carbon capture solvent outlet, a lean carbon capture solvent outlet connected to the lean carbon capture solvent inlet and a captured carbon dioxide outlet;
a first group of sensors, adapted for collecting real-time temperature, pH, density and viscosity data for a lean carbon capture solvent used for capture of an acid gas from the source fluid stream, adjacent the lean carbon capture solvent inlet;
a second group of sensors, adapted for collecting real-time temperature, pH, density and viscosity data for a rich carbon capture solvent following the capture of the acid gas from the source fluid stream, adjacent the rich carbon capture solvent inlet; and
a controller adapted for (a) receiving the real-time temperature, pH, density and viscosity data for both the lean carbon capture solvent and the rich carbon capture solvent, (b) determining carbon loading of the lean carbon capture solvent based upon the real-time temperature data and the real-time pH data for the lean carbon capture solvent and (c) determining carbon loading of the rich carbon capture solvent based upon the real-time temperature data and the real-time pH data for the rich carbon capture solvent.

9. The carbon dioxide capture process system of claim 8, wherein the controller is further adapted for (a) determining alkalinity of the lean carbon capture solvent based upon the carbon loading, the real-time temperature and the real-time density of the lean carbon capture solvent and (b) determining alkalinity of the rich carbon capture solvent based upon the carbon loading, the real-time temperature and the real-time density of the rich carbon capture solvent.

10. The carbon dioxide capture process system of claim 9, wherein the controller is further adapted for (a) determining degradation of the lean carbon capture solvent based upon the carbon loading, the alkalinity and the real-time viscosity of the lean carbon capture solvent or (b) determining degradation of the rich carbon capture solvent based upon the carbon loading, the alkalinity and the real-time viscosity of the rich carbon capture solvent or (c) both.

11. The carbon dioxide capture process system of claim 10, wherein (a) the first group of sensors includes a first temperature sensor, a first pH sensor, a first density sensor and a first viscosity sensor and (b) the second group of sensors includes a second temperature sensor, a second pH sensor, a second density sensor and a second viscosity sensor.

12. The carbon dioxide capture process system of claim 11, further including at least one or more additional sensors adapted for collecting real-time data related to:
(a) CO₂ concentration of the source fluid stream upstream from the source fluid stream inlet;
(b) source fluid stream flow rate through the source fluid stream inlet;
(c) CO₂ concentration of treated fluid stream downstream of the treated fluid stream outlet;
(d) flow rate of captured carbon dioxide downstream from the captured carbon dioxide outlet;
(e) flow rate of carbon capture solvent through the absorber vessel and the stripper;
(f) surface tension of the carbon capture solvent at various locations in the carbon dioxide capture system;
(g) liquid-to-gas ratio in the absorber vessel; and
(h) cooling water temperature at various locations in the carbon dioxide capture system.

13. The carbon dioxide capture process system of claim 12, further including a source of carbon capture solvent and a pump and valve system for delivering fresh carbon capture solvent from the carbon capture solvent source to the absorber vessel wherein the controller controls operation of the pump and valve system to (a) make-up the carbon capture solvent at a rate necessary to maintain a desireable carbon capture solvent quality and (b) periodically replace the carbon capture solvent circulating between the absorber vessel and the stripper.

14. The carbon dioxide capture process system of claim 13, further including a carbon capture solvent reboiler in communication with the stripper wherein the controller controls operation of the reboiler to maintain a desired operating temperature and operating pressure within the stripper.

15. A method of controlling carbon capture in a carbon capture system, comprising:
collecting real-time temperature, pH, density and viscosity data for a lean carbon capture solvent used for capture of an acid gas from a source fluid stream;
collecting real-time temperature, pH, density and viscosity data for a rich carbon capture solvent following the capture of the acid gas from the source fluid stream;
receiving, by a controller, the real-time temperature, pH, density and viscosity data for both the lean carbon capture solvent and the rich carbon capture solvent;
determining, by the controller, carbon loading of the lean carbon capture solvent based upon the real-time temperature data and the real-time pH data for the lean carbon capture solvent; and
determining, by the controller, carbon loading of the rich carbon capture solvent based upon the real-time temperature data and the real-time pH data for the rich carbon capture solvent.

16. The method of claim 15, further including (a) determining, by the controller, alkalinity of the lean carbon capture solvent based upon the carbon loading, the real-time temperature and the real-time density of the lean carbon capture solvent and (b) determining, by the controller, alkalinity of the rich carbon capture solvent based upon the carbon loading, the real-time temperature and the real-time density of the rich carbon capture solvent.

17. The method of claim 16, further including (a) determining, by the controller, degradation of the lean carbon capture solvent based upon the carbon loading, the alkalinity and the real-time viscosity of the lean carbon capture solvent or (b) determining, by the controller, degradation of the rich carbon capture solvent based upon the carbon loading, the alkalinity and the real-time viscosity of the rich carbon capture solvent or (c) both.

18. The method of claim 17, further including locating a first group of sensors adapted for the collecting of the real-time temperature, pH, density and viscosity data for the lean carbon capture solvent upstream from a lean carbon capture solvent inlet in an absorber vessel of a carbon dioxide capture process system.

19. The method of claim 18, further including locating a second group of sensors adapted for the collecting of the real-time temperature, pH, density and viscosity data for the rich carbon capture solvent upstream from a rich carbon capture solvent inlet in a stripper of a carbon dioxide capture process system.
